(19) United States
(12) Patent Application Publication
(10) Pub. No.: US 2016/0193485 A1
(43) Pub. Date: Jul. 7, 2016

(54) EMERGENCY BREATHING APPARATUS

(71) Applicant: Nofel Izz, Mississauga (CA)

(72) Inventor: Nofel Izz, Mississauga (CA)

(21) Appl. No.: 14/590,606

(22) Filed: Jan. 6, 2015

(51) Int. Cl. A62B 18/04; A62B 19/00; A62B 9/06; A62B 18/10

(52) U.S. Cl. CPC A62B 18/04; A62B 18/10; A62B 19/00; A62B 9/06

(57) ABSTRACT

The present invention relates to an emergency breathing apparatus for providing a steady supply of breathable air, the apparatus comprising: a hood, wearable over the human head using an access opening at a lower end and a securing means for tightening and sealing the access opening of the hood. The apparatus further comprises a user operable air supply unit, coupled to the hood for supplying breathable air and an inflatable collar, for creating a seal around the neck upon activation.

### CROSS-REFERENCE TO RELATED APPLICATION

This application claims benefit of priority of U.S. Application 61/924,357 filed on Jan. 7, 2014 entitled “Safety Breathing Apparatus” owned by the assignee of the present application and herein incorporated by reference in its entirety.

### FIELD OF THE INVENTION

The present invention generally relates to a breathing apparatus for use in an emergency situation and more particularly relates to a respiratory hood providing oxygen supply for breathing purposes under critical and emergency situations.

### BACKGROUND OF THE INVENTION

Protective breathing devices including emergency respiratory masks are commonly used to facilitate safe breathing in critical situations, such as during fire emergencies, chemical hazard, water rescue operations, biological hazards and industrial gas hazards. Breathing masks, in addition to providing oxygen supply, also filters air from particulate and toxic contaminants, etc.

It is common on aircraft to provide a breathing apparatus of the type where a mask or partial mask is provided when oxygen is required. Such breathing devices are typically on stand-by and are connected to a source of oxygen and may be placed over a face in the state of an emergency. Although these masks perform their intended function of supplying air, still there are situations where lightweight portable system has its own advantages. There are also situations where air is only required for a very short term. For example, if a car crashes through a guard rail and is submerged under water, the occupant for a few critical minutes, until escape is possible, requires air to breathe. Another example, In a situation where there is a fire in a building and being able to breath air from an air supply without being disabled by inhaling smoke could potentially provide time to exit the burning building.

U.S. Pat. No. 5,875,775 discloses a protective breathing mask comprising fire-resistant stretchable material. U.S. Pat. No. 8,037,547 shows a protective hood is provided for protecting a wearer's head from environmental elements. U.S. Pat. No. 6,247,471 shows an emergency breathing device for providing a user with breathable oxygen and protection. U.S. Pat. No. 6,5108,50 shows an emergency breathing apparatus incorporating gas storage vessel comprising a polymeric container system for pressurized fluids.

However, existing breathing devices comprises limitations in terms of portability and additional features such as lack of features like floatation support, provision for manual supply of air and secondary mouthpiece for usage of the apparatus without wearing the hood. Therefore, there still exists a need for an improved, easy to handle emergency breathing apparatus for providing users with a steady supply of breathable air during critical situations.

### SUMMARY OF THE INVENTION

The present invention relates to an emergency breathing apparatus for providing a steady supply of breathable air, the apparatus comprising: a hood, wearable over the human head using an access opening at a lower end and a securing means for tightening and sealing the access opening of the hood. The breathing apparatus further comprises a user operable air supply unit, coupled to the hood for supplying breathable air. An inflatable collar, for creating an air-tight seal around the neck and the inflatable collar also acts as a floatation support upon activation.

In an embodiment, the emergency breathing apparatus of the present invention comprises an inflatable collar consisting of gel foam material, which acts as a securing means for creating an air tight seal and also acts as a floatation support in water, upon activation of the inflatable material by the user. The apparatus further comprises an inflatable material at the top, which acts as floatation support.

In another embodiment, the emergency breathing apparatus of the present invention comprises a mouthpiece at the top portion enabling manual supply of breathing air by another person and additional mouthpiece near the elastic collar for accommodating additional person, in need to receive breathing air. The mouthpiece also allows direct supply of breathing air to the user, without having the need to wear the hood over the user's head.

### BRIEF DESCRIPTION OF DRAWINGS

FIG. 1 is a front view of the breathing apparatus before activation, according to an embodiment of the present invention.

FIG. 2 is a front view of the breathing apparatus after activation, according to an embodiment of the present invention.

FIG. 3 is a side view of the breathing apparatus according to an embodiment of the present invention.

FIG. 4 is a cross sectional view of the breathing apparatus according to an embodiment of the present invention.

FIG. 5 is a front view of the breathing apparatus according to a different embodiment of the present invention.

FIG. 6 is a side view of the breathing apparatus according to a different embodiment of the present invention.

FIG. 7 is a front view of the breathing apparatus with mouthpiece according to a different embodiment of the present invention.

FIG. 8 is a front view of the breathing apparatus with mouthpiece and removable breathing ring in a detached state according to a different embodiment of the present invention.

### DETAILED DESCRIPTION OF THE INVENTION

The following detailed description of the preferred embodiments presents a description of certain specific embodiments to assist in understanding the claims. However, the present invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be evident to one of ordinary skill in the art that the present invention may be practiced without these specific details.

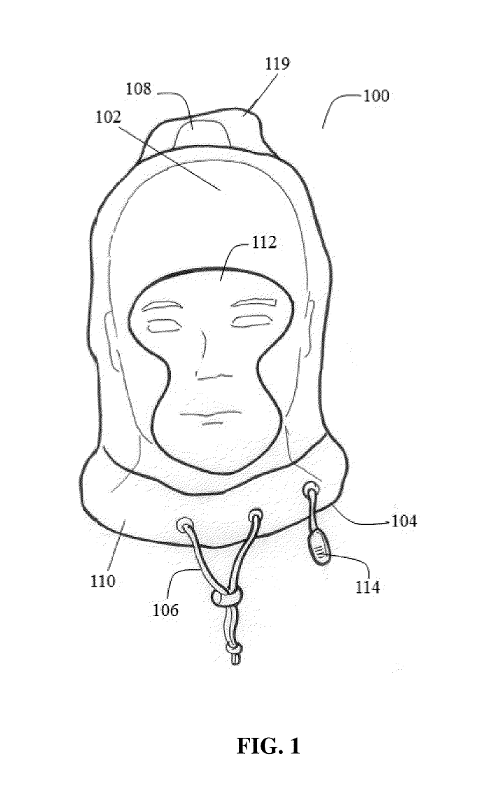

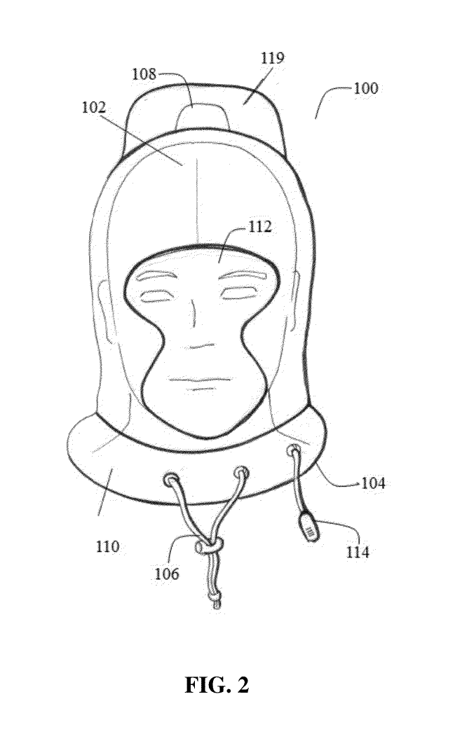

Referring to FIGS. 1 and 2, which shows a front view of an emergency breathing apparatus before and after activation of the apparatus respectively. The apparatus 100 comprises a hood 102 that is wearable over the head of a user using an access opening 104 at the lower end and the hood can be tightened and sealed around the neck using a cord 106. An air supply unit 108, operable by the user for supplying breathable air within the hood for a certain period of time during emergency situations. The apparatus further comprises an inflatable collar 110 at the neck region, wherein the collar 110 comprises a gel foam material which can be inflated upon activation. The air supply unit 108 can be activated by accessing an activating means 114 after donning the hood and sealing around the neck.

The apparatus further comprises an inflatable material 116 covering a substantial area at the top of the head, which upon activation, acts as a floatation support in water during emergency situation such as water related accidents or rescue operations. A transparent shield 112 in the front, covering eyes and substantial area of the face, for protected vision.

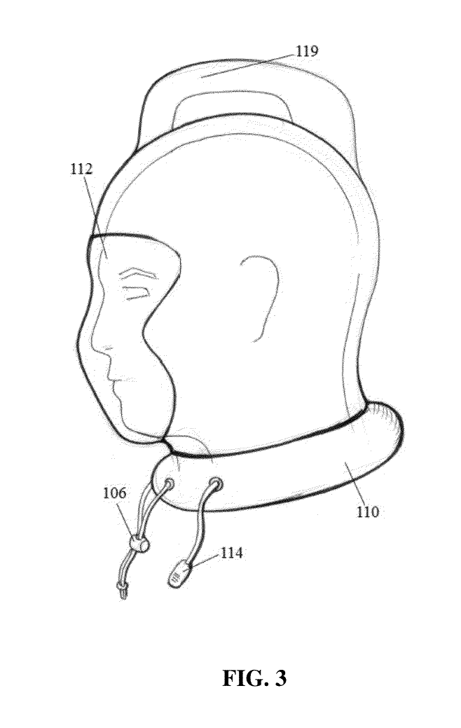

FIG. 3 shows a side view of the emergency breathing apparatus after activation. Upon wearing the hood and securing around the neck using securing cord 106, the air supply unit can be activated by accessing the activating means comprising a separate cord 114. Air supply unit provides a steady supply of breathable air within the hood for the user to breathe and the inflatable material 116 at the top and collar 110 region, upon inflation offers floatation support. The transparent shield 112 offers protected vision to the user during critical situations.

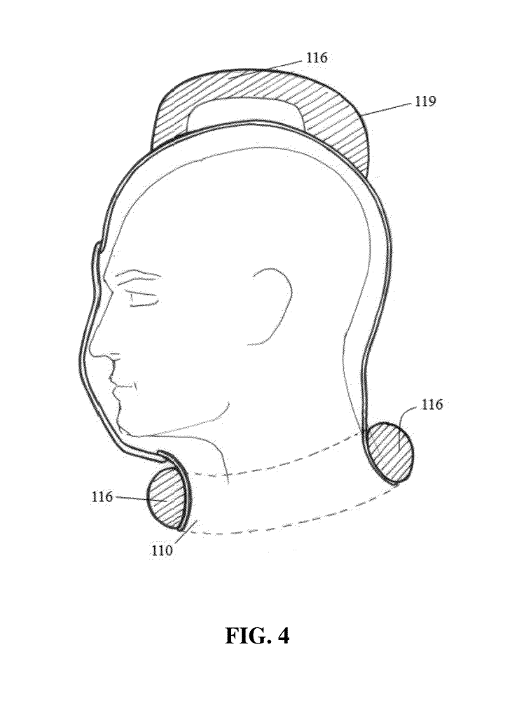

FIG. 4 illustrates a cross sectional view of the emergency breathing apparatus. The inflatable material 116 present within the collar 110 around neck and covering a substantial portion of the head region 119, comprises gel foam or inflatable polymeric material which gets expanded via chemical reaction or via external gaseous source such as carbon dioxide. In an embodiment, the air supply unit and the inflatable material can be activated together by an activating means which provides supply of air for breathing as well as inflating.

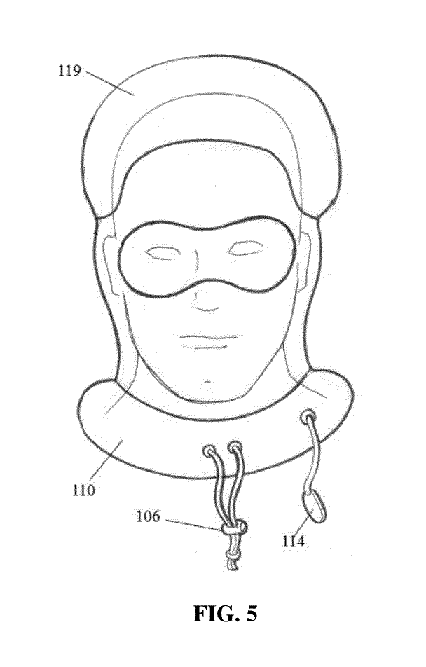

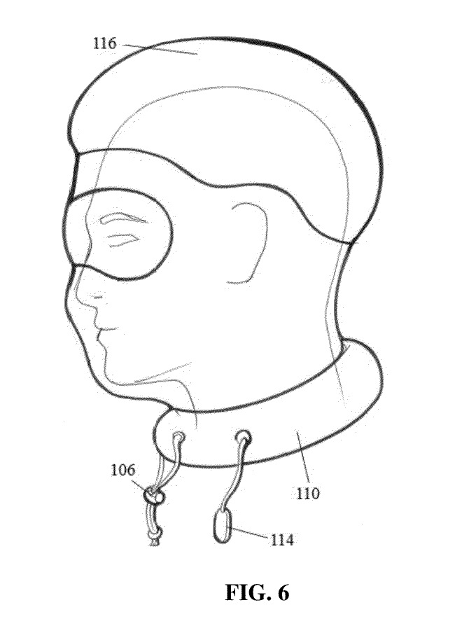

FIG. 5 and FIG. 6 illustrates a front view and side view of the emergency breathing apparatus respectively according to a different embodiment of the present invention. After securing the hood around the neck using the cord 106, the air supply unit can be activated by accessing the cord 114, which not only provides breathing gas supply to the user but also expands the inflatable material at the collar 110 and head 119 region. The primary function of inflatable collar 110 is to create an air tight seal around the neck in order to prevent leakage of breathing gas thereby attaining maximum usage of supplied air available within the hood. In addition to providing air tight seal, the inflatable collar together with the inflatable material at the head region, upon expansion offers floatation support in water body.

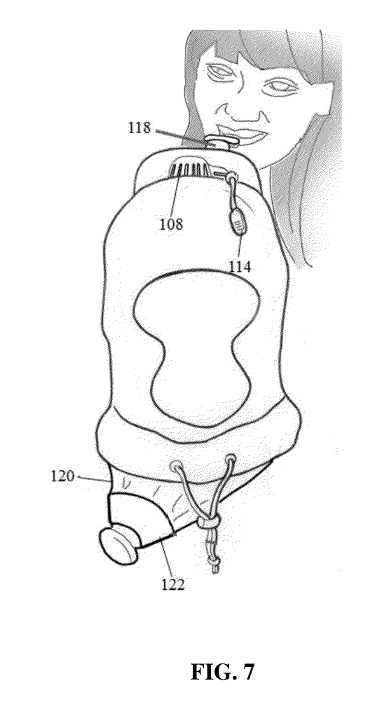

FIG. 7 a front view of the breathing apparatus with mouthpiece according to a different embodiment of the present invention. The apparatus may further comprise a mouthpiece 118, which enables providing breathing air supply by another person. For example, the apparatus can be worn by a child and parent can provide breathing air through the mouth piece 118. In another scenario, the mouth piece 118 allows manual supply of air, independent of the air supply unit 108 or as a supplementary air source besides the air supply unit 108 activated by the activating means 114.

In another embodiment the apparatus may further comprise an additional mouth piece 120 fitted to an elastic collar adjacent to the neck region. A removable breathing ring 122 is attached to the mouth piece, which can be detached and the mouthpiece allows to accommodate a second person to receive breathing air supply. In yet another embodiment, the mouth piece can be placed over the mouth and nose region by the user for receiving breathing air, without the need to wear the whole hood apparatus over the head.

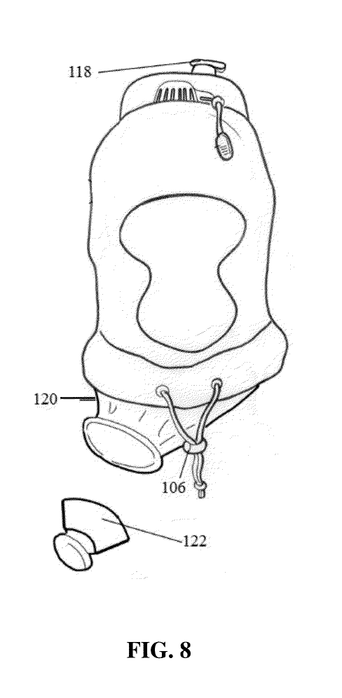

FIG. 8 illustrates a front view of the breathing apparatus with breathing ring detached according to an embodiment of the present invention. The breathing ring 122 can be detached from the mouth piece 120, after sealing the apparatus around the user's neck by pulling and securing the cord 106. In an embodiment, the mouth piece 118 and additional mouth piece 120 can accommodate two additional persons to receive breathing air in addition to the primary user wearing the breathing apparatus.

In an embodiment, the breathing apparatus further comprise a filter unit for filtering the air from harmful elements in air and toxic particles. For example, the filter prevents inhalation of harmful smoke during fire accidents, microbial agents during biological warfare and laboratory settings.

In another embodiment, the breathing apparatus comprises a one way valve, allowing exhaustion of expelled air from the user. The valve, by allowing expelled air from the user to escape, also helps in preventing fogging of transparent shield, thus providing unobstructed vision to the user. In addition, an inlet valve may also be present for controlling air flow and pressure.

In an exemplary embodiment, the breathing apparatus can be worn over the head during emergency situation such as submerged vehicle or fire accident, etc. The hood or air bag is made of fire retardant and water proof material. The hood is provided with an inflatable gel foam and an elastic collar in order to make it air tight, which is activated by cinching the cords in front of the neck region. Once the collar is in place, the cords are pulled to activate the oxygen supply that is located on top or at the bottom of the collar. This enables the oxygen to be pumped into the hood, providing a steady supply of oxygen for breathing purposes. The oxygen levels are kept steady within the hood for a required period of time by a valve on the surface of the bag that allows excess air to escape without letting water inside the hood or air bag.

The present invention has been described with a preferred embodiment thereof and it is understood that many changes and modifications to the described embodiment can be carried out without departing from the scope and the spirit of the invention that is intended to be limited only by the appended claims.

1. An emergency breathing apparatus for providing a supply of breathable air, the apparatus comprising:
a hood, wearable over the human head using an access opening at a lower end and a securing means for tightening and sealing the access opening; and
a user operable air supply unit, coupled to the hood, for providing breathable oxygen and an inflatable collar, for creating a seal around the neck upon activation.

2. The apparatus of claim 1, further comprises an inlet valve for controlling air flow and pressure.

3. The apparatus of claim 1, further comprises an outlet valve for exhausting exhaled air.

4. The apparatus of claim 1, further comprises a transparent shield covering a substantial area of the user's face.

5. The apparatus of claim 1, further comprises an air filter.

6. The apparatus of claim 1, further comprises a primary mouthpiece for manual air supply.

7. The apparatus of claim 1, further comprises an elastic collar at the lower end of the hood.

8. The apparatus of claim 7, wherein the elastic collar comprises a secondary mouthpiece closed with a removable breathing ring.

9. The apparatus of claim 8, wherein the secondary mouthpiece is used for directly used for breathing without wearing the hood.

10. The apparatus of claim 1, is made of a water proof material.

11. The apparatus of claim 1, is made of a fire retardant material.

12. The apparatus of claim 1, wherein the inflatable collar comprises a gel foam material.

13. The apparatus of claim 1, wherein the inflatable collar provides a floatation support.

14. The apparatus of claim 1, wherein the air supply unit and the inflatable collar comprises separate means for activation or combined means for activation.

15. The apparatus of claim 1, further comprises an inflatable section at top, providing floatation support in an inflated state.
